(19) United States
(12) Patent Application Publication
(10) Pub. No.: US 2002/0190059 A1
(43) Pub. Date: Dec. 19, 2002

(54) Electrical heating pads

(76) Inventor: Ku Shen Lam, Hong Kong (HK)

Correspondence Address: JACKSON WALKER L.L.P., 112 E. Pecan Street, Suite 2100, San Antonio, TX, 78205, US

(21) Appl. No.: 09/883,767

(22) Filed: Jun. 18, 2001

(51) Int. Cl. H05B 3/34

(52) U.S. Cl. 219/528; 219/549

(57) ABSTRACT

An electric heating pad comprises a substrate carrying an insulated single strand of a carbon fibers bundle that is arranged to be supplied by power from a pair of batteries. The batteries are carried in a closable case supported in a pouch formed in a top cover. The membrane has an adhesive lower layer which is protected by a peel-off cover when the pad is not in use. The pad is placed against an area of a human body requiring heat treatment, the batteries are placed in the case and heat applied automatically without supervision. Heating can be carried out for 5 hours when fully charged batteries are used.

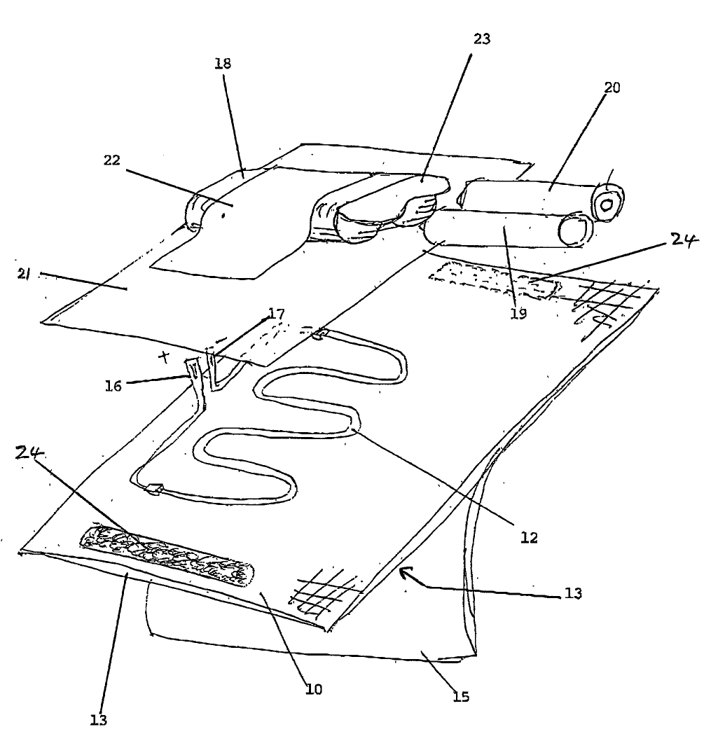

### BACKGROUND OF THE INVENTION

1. Field of the Invention

The invention relates to electric heating pads.

2. Description of Prior Art

It is known to provide pads for localised heating of body parts of medical patients and to provide pads that are built-in to articles of clothing, such as jackets, shoes and gloves. It is also known to drive such -pads using portable battery packs and so operate heating, elements at relatively low voltages. Broadly stated, currently available heating pads are pre-fixed in or part of other articles and relatively expensive and/or require control circuits, including switches.

### SUMMARY OF THE INVENTION

It is an object of the invention to overcome or at least reduces these problems.

According to the invention there is provided an electrical heating pad comprising a substrate carrying a direct current heating element having a positive and negative terminal extending to a battery pack pouch supported by the substrate, and an adhesive layer for holding the substrate against a surface to be heated.

The heating element may be a single insulated strand, of carbon fibres, laid in a tortuous path on the substrate.

The substrate is preferably a thin flexible plastic planar membrane having an upper and a lower surface, in which the heating element is supported by the upper surface and at least a substantial part of the lower surface is covered by the adhesive layer.

The adhesive layer may comprise Velcro (trade mark) material.

The flexible membrane that covers the heating element may be formed with the battery pouch.

The pouch may be arranged to slidingly receive and hold two or more batteries.

The pouch may be provided with a rigid elongate battery case for receiving the two or more batteries.

The case may have a releasably closable door at one end through which the batteries can enter the case.

### BRIEF DESCRIPTION OF THE DRAWINGS

A disposable electric heating pad according to the invention will now be described by way of example with reference to the accompanying isometric exploded view of the pad.

### DESCRIPTION OF THE PREFERRED EMBODIMENT

Referring to the drawings, the pad comprises a thin planar plastics membrane 10 having an upper surface 11 to which a zig-zag single insulated strand 12 formed of carbon fibres conductors is attached, providing an electric heating element. A lower surface 13 is covered with a layer 14 of adhesive material. The layer 14 is covered by a peel-off protective membrane 15.

The heating element 12 is terminated by contacts 16 and 17 that are positioned inside an end of an elongate battery case 18 to contact a positive terminal of one battery 19 and a negative terminal of another battery 20 respectively in use. A top membrane cover 21 for the heating element 12 is formed with a pouch 22 into which the case 18 can slide and be held in position. The case 18 has a releasably closable door 23 that carries a bridging conductor (not shown) on its inner surface to electrically connect respective terminals of the batteries 19 and 20 when the door is closed.

A strip of VELCRO (trade mark) 24 is provided along each end of the membrane 10 that are arranged to inter engage when the membrane 10 is placed to surround a limb of patient so as to hold the pad in position during use.

In use, the pad is used to apply localised heating to a part of a body or a patient, such as a shoulder blade, elbow, knee joint and so forth, as required. The layer 15 is first peeled off and the membrane 10 is pressed against and adhered to the body part. The batteries 19 and 20 are placed in the case 18 and the door 23 closed. Power supplied by the batteries 19 and 20 causes the heating element 12 to heat up. The batteries are removed after a chosen time period, or, in some cases, allowed to fully discharge to provide, say, 4 to 6 hours of heat treatment. After treatment the pad is disposal of. In other words, the pad is used only once.

In a typical arrangement, batteries are chosen to operate the heating element at between 1 and 6 Volts. The strand includes 30 carbon fibres and has a resistance of 30 ohms per meter. The strand is 10 to 40 cms in length. The membrane 10 is 15×5 oms in area, and if two AA alkaline batteries are used, heating for about 5 hours is provided.

The heating element may alternatively comprises a layer formed by an area of carbon fibre based gauze material and the battery connected to cause a current to flow end-to-end across the gauze material.

The pads described are believed to have a principle application for human or animal heat therapy. However many other applications are envisaged where a ‘cheap’ unsupervised source of intimate area heating is required. Such applications include incubating live eggs, curing thermosetting resin in situ, heating a small vessel of liquid, de-frosting a door lock and so forth.

I claim:

1. An electrical heating pad comprising a substrate carrying a direct current heating element having a positive and negative terminal extending to a battery pack pouch supported by the substrate, and an adhesive layer for holding the substrate against a surface to be heated.

2. An electrical heating pad according to, claim 1, in which the heating element is a single insulated strand, made up of carbon fibres, laid in a tortuous path on the substrate.

3. An electrical heating pad according to claim 1, in which the substrate is a thin flexible plastic planar membrane having an upper and a lower surface, in which the heating element is supported by the upper surface and at least a substantial part of the lower surface is covered by the adhesive layer.

4. An electrical heating pad according to claim 1, in which the adhesive layer comprises at least in part Velcro (Trade Mark) material.

5. A electrical heating pad according to claim 3, including a flexible membrane that covers the heating element that is formed with the battery pouch.

6. An electrical heating pad according to claim 5, in which the pouch is arranged to slidingly receive and hold two or more batteries.

7. An electrical heating pad according to claim 6, in which the pouch is provided with a rigid elongate battery case for receiving the two or more batteries.

8. An electrical heating pad according to claim 6, in which the case has a releasably closable door at one end through which the batteries can enter the case.
